(19) United States
(12) Patent Application Publication
(10) Pub. No.: US 2015/0074571 A1
(43) Pub. Date: Mar. 12, 2015

(54) GRAPHICAL USER INTERFACE FOR BROWSING A LIST OF VISUAL ELEMENTS

(71) Applicant: Swisscom AGA, Bern (CH)

(72) Inventors: Urs-Viktor Marti, Munchenbuchsee (CH); Alexander Schnepp, Koln (DE); Alexander Schradt, Fallanden (CH)

(21) Appl. No.: 14/481,170

(22) Filed: Sep. 9, 2014

(30) Foreign Application Priority Data
Sep. 9, 2013 (EP) 13004381.3

(51) Int. Cl. G06F 3/0481; G06F 17/30; G06F 3/0484

(52) U.S. Cl. CPC G06F 3/0481; G06F 3/04842; G06F 17/30994
USPC 715/765

(57) ABSTRACT

Methods and systems are provided for configuring a graphical user interface that is used for browsing a list of visual elements. The graphical user interface may be configured to display consecutive visual elements, displaying one visual element, selected as a focus element, in a focus area of the graphical user interface, and displaying one or more of the consecutive visual elements, preceding or following the focus element in the list, as non-focus elements outside the focus area, at particular display positions. When focus is moved, a different visual element may be displayed in the focus area and the remaining visual elements may be displayed at rearranged display positions. The display positions may be arranged along two or more presentation lines running through the focus area, with the position of each visual element being representative of a visual element's position in the list with respect to the focus element.

### CLAIM OF PRIORITY

Pursuant to 35 U.S.C. §119, this patent application claims the filing date benefit of and right of priority to European (EP) Patent Application No. 13004381.3, filed Sep. 9, 2013. The above application is hereby incorporated herein by reference in its entirety.

### FIELD

The present disclosure relates to electronic devices and use thereof. More specifically, certain embodiments of the disclosure relate to a graphical user interface for browsing a list of visual elements and to a method of controlling a graphical user interface for browsing the list of visual elements.

### BACKGROUND

Existing solutions in the field of graphical user interfaces may have various shortcomings and/or may be inefficient (e.g., create considerable cognitive burdens on users performing interactions and/or having inefficient man-machine interactions). Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE DISCLOSURE

A system and/or method is provided for a graphical user interface for browsing a list of visual elements, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF THE DRAWINGS

Various features and advantages of the disclosure will become apparent from the following description of non-limiting exemplary embodiments, with reference to the appended drawings, in which:

FIG. 1 illustrates an example graphical user interface for a list of visual elements.

FIG. 2 illustrates an example graphical user interface after receipt of a shift left command.

FIG. 3 illustrates an example graphical user interface after receipt of a shift right command.

FIG. 4 illustrates an example graphical user interface after receipt of a delete right command.

FIG. 5 illustrates an example graphical user interface having visual elements arranged and displayed on three presentation lines.

FIGS. 6a and 6b illustrates an example graphical user interface having visual elements displayed in an overlapping fashion, before and after having moved focus to a new focus element.

FIG. 7 illustrates an example computerized device configurable for generating and controlling a graphical user interface for browsing a list of visual elements.

FIG. 8 is a flow diagram of an example process for generating and controlling a graphical user interface for browsing a list of visual elements.

### DETAILED DESCRIPTION OF THE DISCLOSURE

As utilized herein the terms “circuits” and “circuitry” refer to physical electronic components (“hardware”) and any software and/or firmware (“code”) which may configure the hardware, be executed by the hardware, and or otherwise be associated with the hardware. As used herein, for example, a particular processor and memory may comprise a first “circuit” when executing a first plurality of lines of code and may comprise a second “circuit” when executing a second plurality of lines of code. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the terms “block” and “module” refer to functions than can be performed by one or more circuits. As utilized herein, the term “example” means serving as a non-limiting example, instance, or illustration. As utilized herein, the terms “for example” and “e.g.,” introduce a list of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled, or not enabled, by some user-configurable setting.

Certain embodiments of the present disclosure may be found in a method and system for a graphical user interface for browsing a list of visual elements, as described in the following in more detail with reference to the attached figures. In this regard, a graphical user interface is provided for browsing a list of visual elements, which does not have at least some of the disadvantages of the prior art. The present disclosure provides enhanced solutions—e.g., those lowering the cognitive burden of a user performing computer interactions and having the technical effect of a more efficient man-machine interface. Hence, efficiency of a graphical user interface is improved to some extent. In particular, a graphical user interface is provided for browsing a large number of visual elements with improved efficiency.

According to the present disclosure, the graphical user interface may be implemented via any suitable electronic (e.g., computerized) device or system. The graphical user interface may be configured to display a plurality of consecutive visual elements of the list by displaying one of the consecutive visual elements, selected as focus element, in a focus area of the graphical user interface. The consecutive visual elements, which may precede or follow the focus element in the list, may be displayed as non-focus elements outside the focus area at display positions arranged along two or more presentation lines running through the focus area. The display positions relative to the focus area may be representative of a visual element's position in the list with respect to the focus element.

The graphical user interface may be further configured to receive user input which may move focus to a different visual element, and to display, in response to the user input, the different visual element in the focus area and the consecutive visual elements, preceding or following the different visual element in the list, as non-focus elements outside the focus area at rearranged display positions along the presentation lines. The rearranged display positions relative to the focus area may be representative of a visual element's position in the list with respect to the different visual element. By displaying the visual elements on multiple lines, a large number of visual elements may be perceived by a user at the same time, substantially more than would be possible on one single presentation line. When the visual elements are displayed, after the focus has moved to a different visual element, the visual elements preceding and following the focus element may be still perceived by the user of the graphical user interface with their respective order within the list of visual elements as well as with respect to the position of the newly selected focus element. Accordingly, the graphical user interface may make it possible for a user to browse through a large list of visual elements while at the same time perceiving their respective order. Specifically, the graphical user interface may be implemented by a processor which may be connected to and controls a display device.

In an example embodiment, the graphical user interface may be configured to arrange the non-focus elements in a cyclical fashion on the presentation lines. A cycle may be defined by the number of presentation lines and a corresponding number of consecutive visual elements in the list, which are each arranged on a different one of the presentation lines using a defined order. In a linear order, for example, the visual elements that are not in focus may be assigned consecutively to the next neighboring presentation line in a given direction, until there is no further neighboring presentation line in that direction and the visual element is assigned to the presentation line located the farthest in the opposite direction. In instances where there may be only two presentation lines, consecutive visual elements may be assigned alternately to the two neighboring presentation lines. In instances where there may be more than two horizontal lines, consecutive visual elements may be assigned, for example, beginning with the bottom line, for example, then the next higher line, etc., until the top line is reached and a new cycle is started by assigning the next visual element in the list to the bottom line. Thus, the order of the visual elements in the list is represented graphically not only in one direction or dimension (in the direction of the presentation lines), but in two directions or dimensions (in the direction of and across the presentation lines).

In an example embodiment, the graphical user interface may be configured to display the non-focus elements with a distance to the focus element that may reflect for a particular visual element its position in the list with respect to the focus element. The distance increases with every position farther from the focus element in the list of visual elements. Arranging the visual elements with a distance to the focus element that corresponds to an element's relative position in the list may make it possible for the user to perceive easily an element's position in the list relative to the focus element and other elements in the list. By further arranging the non-focus elements in a cyclical fashion on the presentation lines, the order of the visual elements in the list may be represented graphically in two directions or dimensions, while the distance of the non-focus elements to the focus element indicates a particular element's relative position in the list; thus, the display area may be used efficiently to present to the user a larger number of visual elements than would be possible on one single presentation line, while still making it possible for the user to recognize easily and clearly the order and relative positions of the visual elements in the list.

In an example embodiment, the graphical user interface may be configured to move focus, in response to user input, to the visual element directly preceding or directly following the focus element. For example, the graphical user interface may be configured to receive from the user a “shift focus left” or “shift focus right” command, respectively, and to rearrange the visual elements accordingly along the presentation lines with respect to the newly selected focus element. The graphical user interface is therefore adapted for browsing or scrolling efficiently through a large list of visual elements, in a user specified direction (e.g., left, right, up, down), while enabling the user to perceive the order of the visual elements at any time.

In an example embodiment, the graphical user interface may be configured to move focus, in response to user input, to a selected one of the non-focus elements. Thus, the graphical user interface may be configured to receive from the user a “set focus” or “select element for focus” command, and to rearrange the visual elements accordingly along the presentation lines with respect to the newly selected focus element. The graphical user interface is therefore adapted to change focus efficiently to any user selected element in a large list of visual elements, while enabling the user to perceive the order of the visual elements at any time.

In an example embodiment, the graphical user interface may be configured to display the focus element in a focus area positioned in a central location of the graphical user interface, with a size larger than that of the non-focus elements.

In an example embodiment, the graphical user interface may be configured to display the focus element at display positions arranged along essentially parallel presentation lines in a partially overlapping fashion. For example, the presentation lines have an essentially horizontal or vertical orientation.

In an example embodiment, the graphical user interface may be configured to receive a user input which deletes the focus element in the list and moves focus to an adjacent visual element, directly preceding or directly following the focus element prior to its deletion. Thus, the graphical user interface may display, in response to the user input, the adjacent visual element in the focus area and the remaining consecutive visual elements, preceding or following the adjacent visual element in the list, as non-focus elements outside the focus area.

In addition to a graphical user interface configured for browsing a list of visual elements, the present disclosure relates to a method of controlling a graphical user interface for browsing a list of visual elements. The method may comprise: displaying a plurality of consecutive visual elements of the list by displaying one of the consecutive visual elements, selected as focus element, in a focus area of the graphical user interface, and displaying the consecutive visual elements, preceding or following the focus element in the list, as non-focus elements outside the focus area at display positions arranged along two or more presentation lines running through the focus area, where the display positions relative to the focus area are representative of a visual element's position in the list with respect to the focus element; receiving a user input which moves focus to a different visual element; and displaying, in response to the user input, the different visual element in the focus area and the consecutive visual elements, preceding or following the different visual element in the list, as non-focus elements outside the focus area at rearranged display positions on the presentation lines, where the rearranged display positions relative to the focus area are representative of a visual element's position in the list with respect to the different visual element. Specifically, the method may be computer implemented and comprise a processor, which may be connected to and control a display device, performing the steps of the method of controlling a graphical user interface for browsing a list of visual elements.

Moreover, the disclosure further relates to a computer program product comprising a non-transitory computer-readable medium having stored thereon computer program code for controlling one or more processors such that the processor(s) generate a graphical user interface for browsing a list of visual elements, the graphical user interface configured to: display a plurality of consecutive visual elements of the list by displaying one of the consecutive visual elements, selected as focus element, in a focus area of the graphical user interface, and displaying the consecutive visual elements, preceding or following the focus element in the list, as non-focus elements outside the focus area at display positions arranged along two or more presentation lines running through the focus area, where the display positions relative to the focus area are representative of a visual element's position in the list with respect to the focus element; receive a user input which moves focus to a different visual element; and display, in response to the user input, the different visual element in the focus area and the consecutive visual elements, preceding or following the different visual element in the list, as non-focus elements outside the focus area at rearranged display positions on the presentation lines, where the rearranged display positions relative to the focus area are representative of a visual element's position in the list with respect to the different visual element.

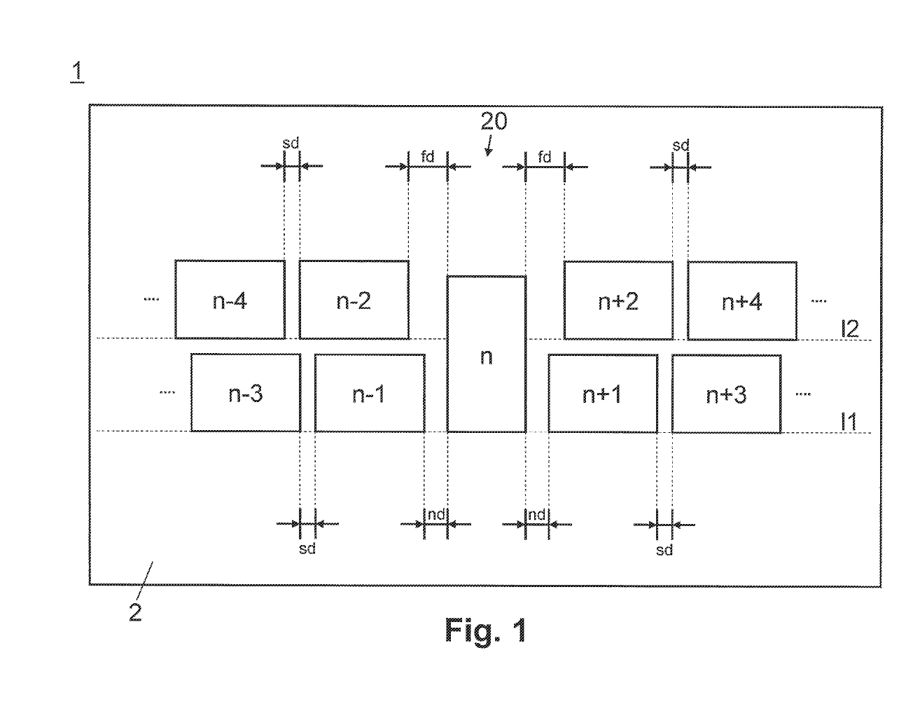

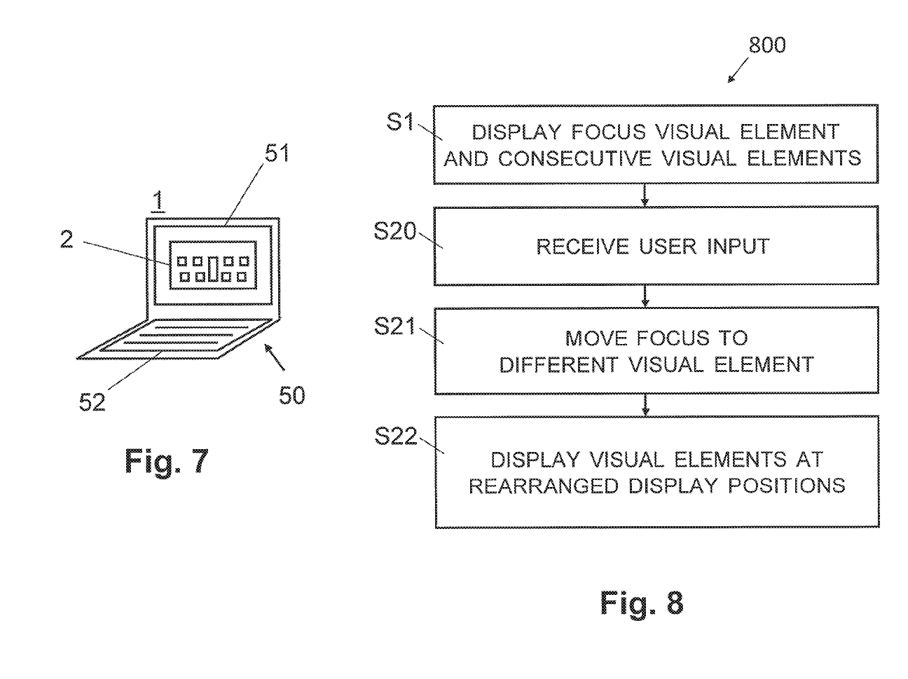

FIG. 1 illustrates an example graphical user interface for a list of visual elements. Shown in FIG. 1 is a graphical user interface 1, which may be displayed on a display area 2. The display area 2 may correspond to at least a region of a display of any suitable electronic device. In this regard, a suitable electronic device may comprise, at least, a display and suitable circuitry for implementing various aspects of the present disclosure. For example, such suitable circuitry may be used, for example, in implementing, configuring, and/or controlling the graphical user interface 1, and/or functions or operations related thereto. An example electronic device is described in more detail below, at least with respect to FIG. 7.

The graphical user interface 1 may be designed and/or implemented for browsing a list of visual elements, each of which may be identified by a corresponding index. For example, as shown in FIG. 1, the list of visual elements may be identified by indices n−4, n−3, n−2, n−1, n, n+1, n+2, n+3, n+4, . . . . The visual elements may comprise any suitable type of visual element which may be displayable (e.g., on the display area 2), such as images, icons, clip art, photos, etc., or any combination thereof. In some instances, the visual elements may be designed to represent any kind of data, such as a film, a musical album, a journal, a newspaper, etc., or any group thereof. Thus, the visual elements may be displayed on the display area 2 in a manner indicative of the data they represent. In case of a film, musical album, journal, etc., the visual element may comprise a cover photo, for example. Accordingly, the graphical user interface 1 may be implemented and/or controlled such that it may provide support for scrolling through a collection of data objects such as a list of films, musical albums, journals, newspapers, groups of films, groups of musical albums, groups of journals, groups of newspapers, etc. For example, the graphical user interface 1 may be configured such that one or more of the visual elements may be selected by a user in order to play back a film or musical album represented by the visual element, display a journal or newspaper, start transmission of data to another electronic device, display further information such as a summary, etc.

In some instances, a visual element may represent a group of films, grouped according to a content classification such as adventure, historical, drama, etc. A visual element may also represent a group of musical albums, grouped according to a content classification such as classical, pop, country, etc. Any other classification may be used to group visual elements. The visual element may represent any other item such as a number, an address, a photo, a drawing, a game, etc., for example, or any group thereof.

The visual elements may be arranged in a linear list according to their indices n−4, n−3, n−2, n−1, n, n+1, n+2, n+3, n+4, . . . . Thus, for example, in the list of visual elements, the visual element with index n−1 may precede the visual element with index n, and the visual element with index n+1 may follow the visual element with index n. In some instances, the visual elements may be increasingly or decreasingly ordered according to any criteria, relating to the data represented by the visual elements for example, such as name, date, cost, relevance, etc. In other instances, the visual elements follow and precede each other randomly.

In an example list of visual elements, the first visual element may be identified by index 1, the second by index 2, the n-th visual element is identified by index n, etc. The number of visual elements in the list is N (which may be any positive integer), wherein the N-th visual element is identified by index N. In particular, the number N of visual elements is large, such as dozens, hundreds, thousands, or more.

When displayed by the graphical user interface 1, the visual elements may have any shape or form, such as rectangular, oval, etc. For example, in FIG. 1 (and the remaining figures), visual elements are shown as having a rectangular shape are described. Nonetheless, it should be understood that the disclosure is not so limited. The visual elements may be displayed by the graphical user interface 1 at a preferred size, and/or size of the visual elements within the list may vary. For example, the visual element with index n maybe displayed at a larger size than other visual elements. In an example implementation, the visual elements may be displayed such that the shape and/or the size of each visual element may depend on the index of the visual element. For example, the visual element with index n is displayed in portrait orientation, whereas other visual elements are displayed in landscape orientation.

In the example implementation shown in FIG. 1, the graphical user interface 1 may be configured such that the n-th visual element n is displayed at a focus area 20 located at a center location of the display area 2. The n-th visual element may be referred to as the focus element. Visual elements with indices n−4, n−3, n−2, n−1 preceding the focus element n may be displayed outside the focus area 20 as non-focus elements (e.g., on the left hand side of (or above) the focus element n), and visual elements n+1, n+2, n+3, n+4 following the focus element n are displayed outside the focus area 20 as non-focus elements (e.g., on the right hand side of (or below) the focus element n). Further, visual elements with indices n−3, n−1, n+1, n+3 (e.g., visual elements having an odd offset to the focus element) may be displayed outside the focus area 20 along a first presentation line l1, to the left and right hand sides of the focus element n, for example. On the other hand, visual elements with indices n−4, n−2, n+2, n+4 (e.g., visual elements having an even offset to the focus element n) may be displayed outside the focus area 20 along a second presentation line l2, to the left and right hand sides of the focus element n, for example. The second presentation line l2 may be arranged parallel to and above the first presentation line l1.

Thus, in the example implementation shown in FIG. 1, on the first presentation line l1, from left to right, the visual elements with indices n−3, n−1 (indices lower than the focus element n) are displayed on the left of the focus element n and the visual elements with indices n+1, n+3 (indices higher than the focus element n) are displayed on the right of the focus element n. Along the second presentation line l2 above the first presentation line l1, from left to right, the visual element with indices n−4, n−2 (indices lower than the focus element n) are displayed on the left side of the focus element n and the visual elements with indices n+2, n+4 (indices higher than the focus element n) are displayed on the right side of the focus element n.

As shown in FIG. 1, the graphical user interface 1 displays a total of nine visual elements in the display area 2. However, as indicated by dots preceding and following the visual elements, any number of visual elements may be displayed. In an implementation, an odd number of visual elements may be displayed, and on the left and the right side of the focus element n, the same number of visual elements may be displayed. However, the number of visual elements displayed on the left and on the right hand sides of the focus element n may be different and/or varied. Moreover, along the first presentation line l1, the visual element with index n−1 preceding the focus element n may be displayed at a near distance nd on the left side of the focus element n. The visual element with index n+1 following the focus element n is displayed at a near distance nd on the right side of the focus element n. Along the second presentation line l2, the visual element with index n−2 preceding the visual element with index n−1 is displayed at the far distance fd on the left side of the focus element n. The visual element with index n+2 following the visual element with index n+1 is displayed at the far distance fd on the right side of the focus element n. The far distance fd is greater than the near distance nd.

As shown in the example implementation depicted in FIG. 1, visual elements that are not directly displayed on the left or right hand sides of the focus element n are displayed with a small distance sd between them, the small distance sd being smaller than the near and far distances nd, fd, for example. In some implementations, however, the length of the distance sd between visual elements that are not directly adjacent to the focus element n may vary, such as depending on the position of the visual elements with respect to the focus element n. The farther away visual elements are positioned from the focus element n, the shorter the distance sd between these elements is set. In an implementation, the distance sd between such elements may be actually negative—e.g., these elements may be positioned and displayed in a partially overlapping fashion. In the overlapping area, the visual element closer to the focus element n may be placed on top of the visual element that is positioned farther away from the focus element n.

Thus, the visual elements n−4, n−3, n−2, n−1, n, n+1, n+2, n+3, n+4, . . . may be displayed by the graphical user interface 1 with different respective distances relative to the focus element n. The visual elements preceding (those with indices n−4, n−3, n−2, n−1) and/or following (those with indices n+1, n+2, n+3, n+4, . . . ) the displayed focus element n may be displayed outside the focus area 20, along a plurality of presentation lines l1, l2, . . . that run through the focus area 20. Further, preceding and following visual elements n−4, n−3, n−2, n−1, n+1, n+2, n+3, n+4, . . . may be displayed on opposite sides of the displayed focus element n, respectively. Visual elements which are directly following each other in the list of visual elements are arranged on different presentation lines l1, l2, . . . . The visual elements are arranged on the presentation lines according to their position with respect to the focus element n in the list of visual elements, an element's distance to the focus element n increasing with every position farther away from the focus element n in the list of visual elements.

The actual measures of the near distance nd, far distance fd, and small distance sd may be defined, for example, depending on the size of the display area 2, the size of the displayed visual elements, the size of the focus area 20, etc. For example, the near distance nd may be defined as a certain percentage (e.g., 10%) of the width of the focus element n displayed at the center location of the display area 2, the far distance fd may be defined as a certain percentage, such as 20%, of the width of the n-th visual element, and the small distance sd may be defined as a certain percentage (e.g., 5%) of the width of the n-th visual element. Any other definition may be used. However, in any case, the near distance nd is smaller than the far distance fd. The small distance sd may be smaller than the near distance nd, it may be between the near distance nd and the far distance fd, or it may be larger than the far distance fd.

The graphical user interface 1 may be designed such that a user can browse or scroll through the visual elements. Specifically, the graphical user interface 1 may be configured to receive a user input, which may comprise a particular command. Examples commands may comprise shift left command, shift fast left command, shift right command, shift fast right command, delete command (e.g., delete right, delete left, and/or delete selection), insert command, page command, select command, set focus command, etc. The user input may be received by activation of a button, such by pressing an arrow key of a keyboard, by activation of a scroll or swipe gesture on a touch screen, etc. The graphical user interface 1 may be configured to rearrange the displayed visual elements according to the specific user input, as described in the following paragraphs. Examples of use scenarios in which visual elements may be (re)displayed and/or (re)arranged, such as in response to use input providing particular commands, are described in more details below.

The graphical user interface 1 as described herein may provide for a compact and clearly perceivable display of a list of visual elements such that more content can be displayed in the display area 2 at the same time, because the visual elements are arranged on several lines, wherein the order of the visual elements is clearly perceivable, because their distance to each other corresponds to their order in the list of visual elements.

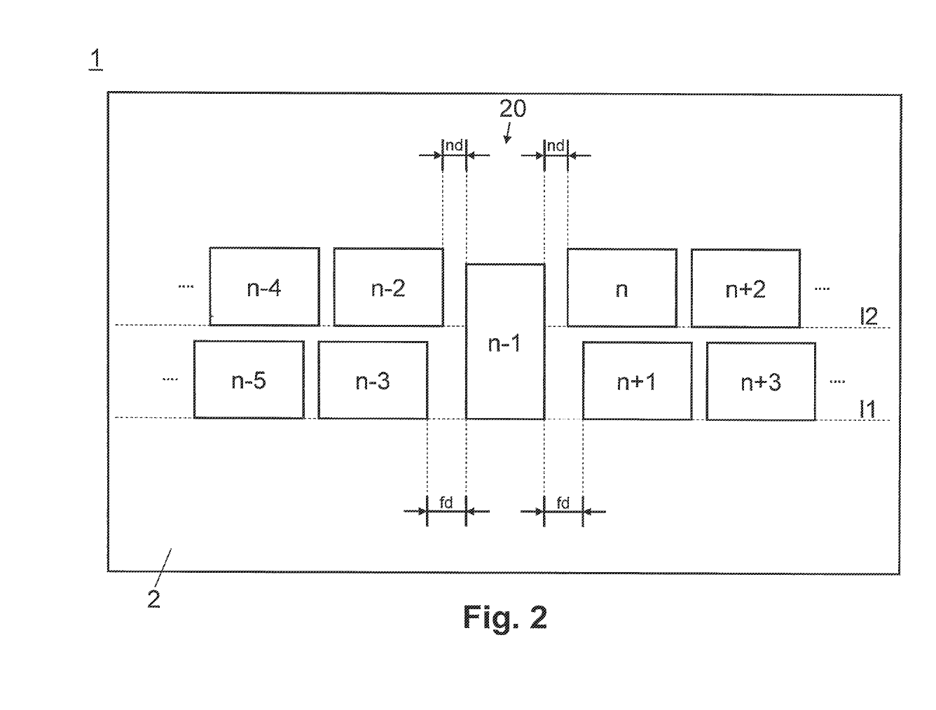

FIG. 2 illustrates an example graphical user interface after receipt of a shift left command. Referring to FIG. 2, there is shown the visual elements displayed by the graphical user interface 1 of FIG. 1 (e.g., relative to the display arrangement shown in FIG. 1), after receipt of a shift left command.

The shift left command may be received, for example, through a swipe or scroll gesture on a touch screen. On receipt of the shift left command, focus may be moved from visual element n to the new focus element n−1. Thus, at the center location of the display area 2, the new focus element n−1 may be now displayed in the focus area 20. The visual element with index n may be displayed outside the focus area 20, on the right side of the center location, and the visual element with index n−2 may be displayed outside the focus area 20, on the left side of the center location. Both the visual element with index n and the visual element with index n−2 may be displayed on the second presentation line l2 at a near distance nd to the focus element n−1. The visual element with index n−3 and the visual element with index n+1 may be still displayed on the first line, but at a far distance fd from the focus element n−1. The remaining visual elements may be displayed accordingly on the respective lines l1, l2 at a small distance sd from each other.

As shown in FIG. 2, a total of nine visual elements may be displayed. Thus, after the shift left command, the visual element with index n+4 is no longer displayed, instead the visual element with index n−5 is newly displayed on the left at a small distance sd from visual element with index n−3. Through the shift left command, the visual element with index n−2 may be displayed on the second presentation line l2 at a near distance nd left to the visual element with index n−1, and the visual element with index n−4 is displayed at a small distance sd left to the visual element with index n−2. In other words, on the second presentation line l2, the block of visual elements comprising the visual elements with indices n−4 and n−2 may be moved from left to right, such that the distance of this block to the focus area 20 in the center location decreases from a far distance fd to a near distance nd.

Other blocks of visual elements may be moved accordingly. Thus, the rearrangement of the visual elements may be limited to only those changes that are necessary, such as moving the visual element with index n−1, as the new focus element n−1, to the focus area 20 in the center location, and moving the visual element with index n out of the center outside the focus area 20, thereby keeping the noticeable visual effect for a user of the graphical user interface 1 to a minimum. The remaining visual elements may be kept close to their original position, though, using the near distance nd and far distance fd as indicators, the user is kept clearly informed about the order of the visual elements in the list of visual elements.

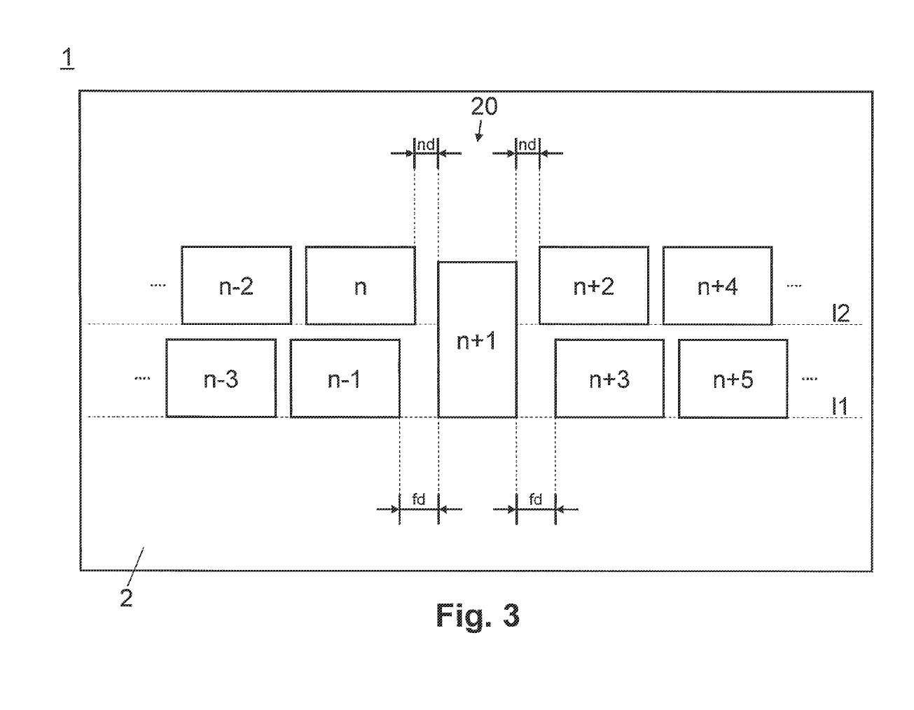

FIG. 3 illustrates an example graphical user interface after receipt of a shift right command. Shown in FIG. 3 are the visual elements as displayed by the graphical user interface 1 after receipt of a shift right command, starting from the graphical user interface 1 as shown in FIG. 1 (e.g., relative to the display arrangement shown in FIG. 1).

The shift right command may be received, for example, through a respective swipe or scroll gesture on a touch screen. On receipt of the shift right command, focus may be moved from visual element n to the visual element n+1. Thus, at the center location of the display area 2, the new focus element n+1 may be now displayed in the focus area 20. The visual element with index n may be displayed outside the focus area 20, on the left side of the center location, and the visual element with index n+2 is displayed outside the focus area 20, on the right of the center location. Both the visual element with index n and the visual element with index n+2 may be displayed on the second presentation line l2 at a near distance nd to the focus element n+1. The visual element with index n−1 and the visual element with index n+3 may be still displayed on the first presentation line l1, but at a far distance fd from the focus element n+1. The remaining visual elements are displayed accordingly on the respective lines l1, l2 at a small distance sd from each other.

In some instances, the shifts commands may result in movement of more than one visual element. For example, with a shift fast left or shift fast right command, which may be entered by the user by way of a correspondingly fast swipe gesture, for example, the focus may not merely moved to one of the neighboring visual elements of the current focus element. Rather, focus may be moved to a visual element that is positioned at a greater distance to the current focus element n−1 in the list of visual elements. Accordingly, the faster the swipe gesture is executed by the user, the farther away from the current focus element the focus may be moved.

Upon receipt of a selection command specifying a selected one of the visual elements as the new focus element, the graphical user interface 1 may display the newly selected focus element in the focus area 20 and rearranges the remaining visual elements outside the focus area 20 as outlined above.

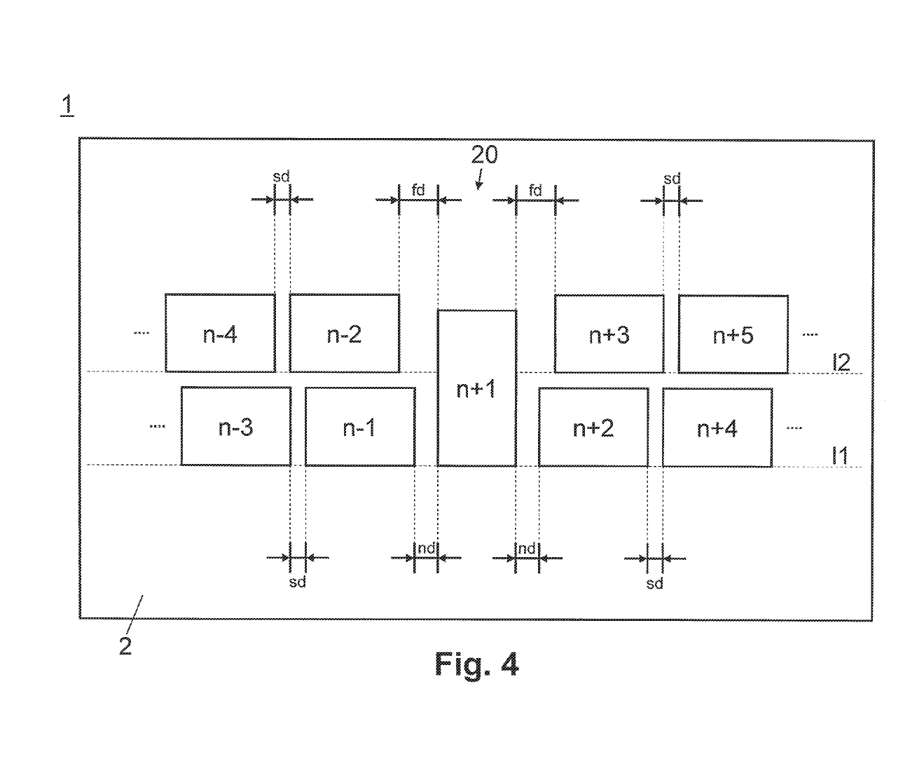

FIG. 4 illustrates an example graphical user interface after receipt of a delete right command. Shown in FIG. 4 are the visual elements displayed by the graphical user interface 1 of FIG. 1, after receipt of a delete right command, starting from the graphical user interface 1 as shown in FIG. 1 (e.g., relative to the display arrangement shown in FIG. 1.

The delete right command may be received, for example, through a respective button press or gesture on a touch screen. Nonetheless, the delete right command may be implemented and/or used in any suitable manner. On receipt of the delete right command, the focus element n is replaced by the focus element n+1. Thus, at the center location of the display area 2, the focus element n+1 may be displayed in the focus area 20. The visual element with index n may be removed from the list of visual elements. As such, the visual element with index n may not be displayed anymore. The visual elements n−1, n−2, n−3, n−4 arranged on the left hand side of the focus area 20 may remain unchanged, in the same position as before the delete operation (as shown in FIG. 1). Thus, the visual element with index n−1 may be still displayed on the first presentation line l1 at a near distance nd from the new focus element n+1. The visual elements n+2, n+3, n+4, n+5 arranged on the right hand side of the focus area 20 may be rearranged, however. For example, the visual element with index n+2 is rearranged and displayed on the first presentation line l1 at a near distance nd to the focus element n+1. The visual element with index n+3 is rearranged and displayed on the second presentation line l2 at a far distance fd from the focus visual element n+1. The remaining visual elements n+4, n+5 are displayed accordingly on the respective lines l1, l2 at a small distance sd from the visual elements n+2 or n+3, respectively.

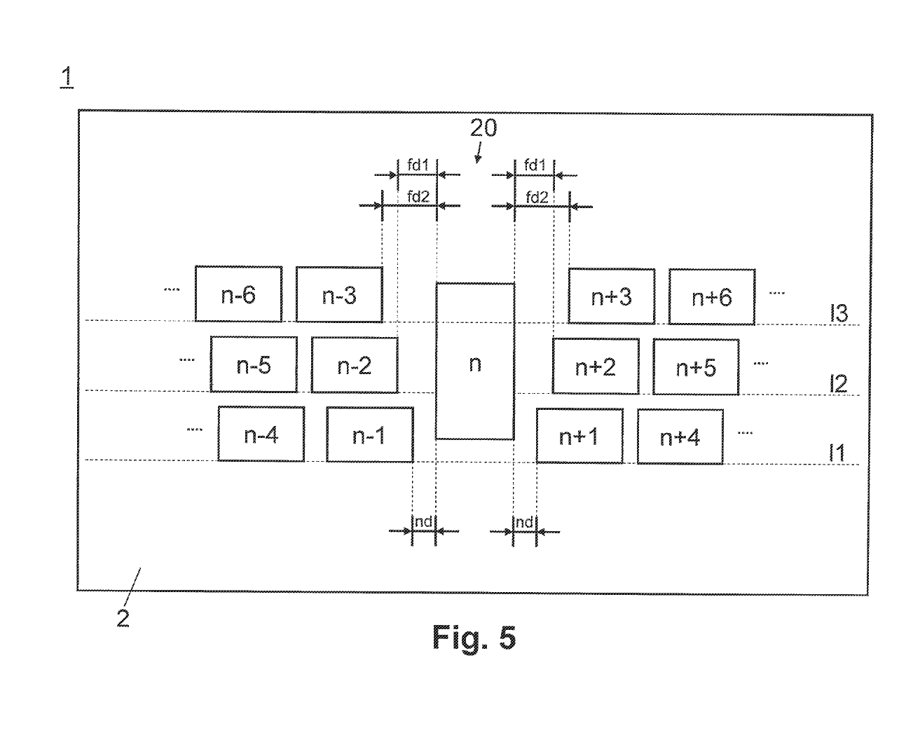

FIG. 5 illustrates an example graphical user interface having visual elements arranged and displayed on three presentation lines. Shown in FIG. 5 is graphical user interface (e.g., the graphical user interface 1 of FIG. 1) having visual elements displayed along three presentation lines l1, l2, l3.

The first presentation line l1 may be at the bottom, with the second presentation line l2 being in the middle, and the third line l3 being at the top. The first presentation line l1, the second presentation line l2, and the third presentation line l3 may be defined in a cyclic group such that for each presentation line l1, l2, l3 a consecutive presentation line l2, l3, l1 is defined. Thus, the second presentation line l2 may be the consecutive line to the first presentation line l1, the third presentation line l3 may be the consecutive line to the second presentation line l2, and the first presentation line l1 may be the consecutive line to the third line l3. The first presentation line l1, the second presentation line l2, and the third presentation line l3 may run through the focus area 20 and, thus, may extend on both sides of the focus element n, which may be displayed in the focus area 20 at the center location of the display area 2.

In some instances, only some of the visual elements in each presentation line may be displayed. For example, on the first presentation line l1, starting from visual elements with indices n−1, n+1, every third visual element is displayed; on the second presentation line l2, starting from visual elements with indices n−2, n+2, every third visual element is displayed; and on the third presentation line l3, starting from visual elements with indices n−3, n+3, every third visual element is displayed. In other words, the consecutive visual elements n+1, n+2, n+3 presentation line displayed along the consecutive first presentation line l1, second presentation line l2, and third presentation line l3. The consecutive visual elements n−1, n−2, n−3 may be displayed along the consecutive first presentation line l1, second presentation line l2, and third presentation line l3. Moreover, cyclically, visual elements n+4, n+5, n+6 may be displayed consecutively along the first, second, and third presentation line l1, l2, l3, as well as visual elements n−4, n−5, n−6, which are also displayed cyclically along the consecutive first, second, and third presentation line l1, l2, l3.

The distance between the focus element n, in the focus area 20, and the visual elements displayed outside the focus area 20 on the three lines may increase, such as according to the position of the visual element with respect to the focus element in the list of visual elements. Thus, the visual elements with indices n−1, n+1 may be displayed at a near distance nd from the focus element n; the visual elements with indices n−2, n+2 may be displayed at a first far distance fd1 from the focus element n; and the visual elements with indices n−3, n+3 may be displayed at a second far distance fd2 from the focus element n. The near distance nd may be smaller than the first far distance fd1, which is smaller than the second far distance fd2. Further visual elements of the list of visual elements are displayed accordingly.

While the visual elements are displayed along three neighboring (consecutive) presentation lines l1, l2, l3 in the implementation shown in FIG. 5, the disclosure is not so limited. Thus visual elements may be displayed along any number m of neighboring (consecutive) presentation lines l1, l2, . . . , lm. The presentation lines may be arranged essentially parallel and may run in a horizontal or vertical direction. Nonetheless, other (curved) forms of presentation lines are possible, without deviating from the scope of the disclosure.

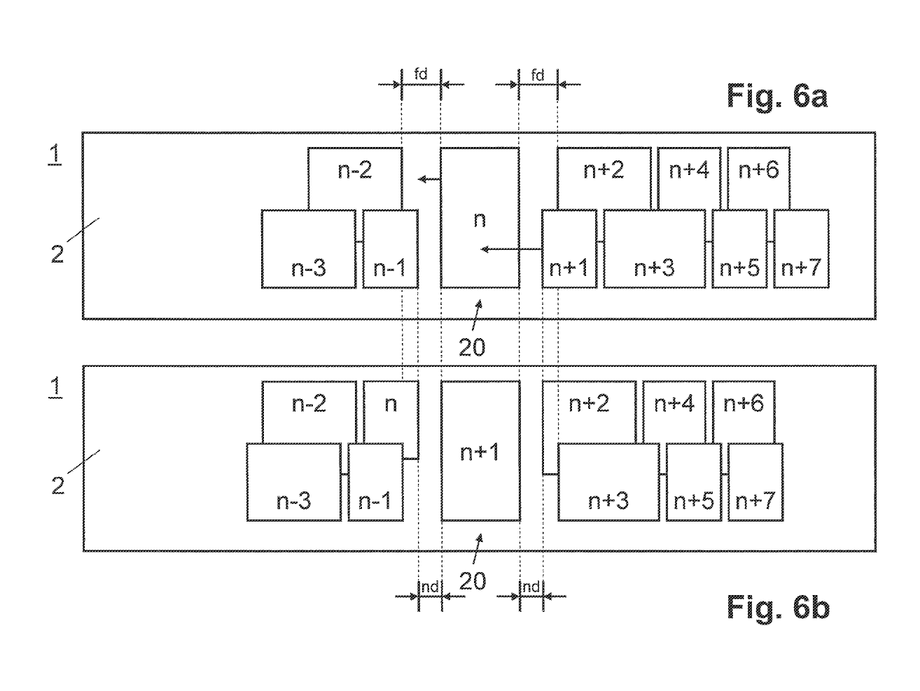

FIGS. 6a and 6b illustrates an example graphical user interface having visual elements displayed in an overlapping fashion, before and after having moved focus to a new focus element. Shown in FIGS. 6a and 6b is a graphical user interface (e.g., the graphical user interface 1 of FIG. 1), where visual elements may be displayed in an overlapping fashion.

In the example implementation depicted FIGS. 6a and 6b, the visual elements may be displayed along two presentation lines. As shown in FIG. 6a, visual elements are displayed in an overlapping fashion such that indices n−3, n−1, n+, n+3, n+5, n+7 may partly cover visual elements with indices n−2, n+2, n+4, n+6. Thus, the density or compactness of displayed elements may be further increased. In an implementation, a title may be displayed together with each visual element, wherein the title may be added at the top or bottom area used to display the visual element, such that the title may always remain visible.

In an example implementation, in instances where focus element n may represent a category of data, if the focus element n is selected by the user for further action (e.g., through particular command, such as “OK” or up command), an additional line of visual elements may be displayed, in addition to the presentation lines already displayed. In an example implementation, a plurality of additional presentation lines with visual elements may be displayed.

The focus element may be changed from a visual element representing a category of data, such as a category of films, into a visual element representing specific data, such as specific film(s) in a respective category—e.g., as shown in the transfer from the original arrangement of visual elements depicted in FIG. 6a to the new arrangement of visual elements depicted in FIG. 6b.

In some instances, focus of the graphical user interface may be then transferred to the additionally displayed presentation lines. The focus of the graphical user interface may be changed back, such as based on a particular command (e.g., upon a back or down command), thus the additionally displayed line or lines may be removed and focus of the graphical user interface is transferred back to the originally displayed lines. For example, the focus element may be changed back from a visual element representing specific data into an element representing a category—e.g., transferring back from the arrangement of visual elements depicted in FIG. 6b to the original arrangement of visual elements depicted in FIG. 6a.

FIG. 7 illustrates an example computerized device configurable for generating and controlling a graphical user interface for browsing a list of visual elements. Shown in FIG. 7 is a computerized device 50.

The computerized device 50 may comprise a display 51, an input device 52, and one or more processors (not shown), each of which comprising suitable circuitry for implementing various aspect of the present disclosure. For example, the one or more processors may be connected to the display 51 and/or the input device 52, and may be configured to control the display 51, such as in response to user input received from the input device 52 for example. The input device 52 may comprise a keyboard, a touchpad, a touch screen and/or a remote control or another device recognizing user gestures. The display 51 may comprise any suitable display. For example, the display 51 may be implemented as an LED, LCD or other visual display.

The computerized device 50 may be implemented, for example, as a personal, mobile, laptop and/or tablet computer; a mobile telephone or other communication device; a television apparatus with a remote control; or any other computerized device comprising a display 51, an input device 52 and at least one processor, e.g., a head-up display or a head-mounted display with voice control, etc. The computerized device 50 or its processors, respectively, are configured to generate on the display 51 a graphical user interface 1 and to control the graphical user interface 1, in response to user input received via the input device 52.

As shown in the example implementation depicted in FIG. 7, the computerized device 50 may be configured to implement the graphical user interface 1, substantially as described with respect to the previous figures, whereby the display area 2 may correspond to a display area in the display 51 of the computerized device 50. In particular, the graphical user interface 1 may implemented (e.g., via one or more processors) as processor-controlled graphical user interface. For example, the computerized device 50 may be configured to implement and/or configure the graphical user interface 1 in accordance with the various example implementations described with respect to FIGS. 1 through 6a/6b.

Visual elements may be stored locally or remotely. Accordingly, the computerized device 50 may comprise a memory component (not shown), comprising suitable circuitry for storing visual elements (and/or data relating thereto) locally, and/or may comprise a communication component (not shown), comprising suitable circuitry for communicating with remote system(s), accessible via suitable telecommunication network(s), to facilitate obtaining the visual elements and/or data relating thereto, which may be stored remotely. For example, each of the visual element indices (e.g., index n−4, n−3, n−2, n−1, n, n+1, n+2, n+3, n+4, . . . ) may define a visual element stored in the memory. Accordingly, visual elements may be accessible through program pointers pointing to the respective location in the memory.

In some instances, where the visual elements are stored remotely (e.g., on a server connected to the Internet), access to the visual element may be defined through its index or link. In addition, data represented by the visual elements, for example a film, a musical album, a journal, may be stored in the memory component of the computerized device 50 and/or remotely, such as on a server connected to the Internet.

FIG. 8 is a flow diagram of an example process for generating and controlling a graphical user interface for browsing a list of visual elements. Process 800 is shown in FIG. 8, comprising an example sequence of steps which may be performed by a computerized device (e.g., the device 50 of FIG. 7) for generating and controlling a graphical user interface for browsing a list of visual elements. In this regard, the sequence of steps of process 800 may be performed by one or more processors of the computerized device 50, for controlling the graphical user interface 1 for browsing a list of visual elements (e.g., elements . . . , n−2, n−1, n, n+1, n+2, . . . ).

In step S1, a plurality of consecutive visual elements . . . , n−2, n−1, n, n+1, n+2, . . . of the list are displayed by displaying one of the consecutive visual elements, selected as focus element n, in a focus area 20 of the graphical user interface 1, and displaying the consecutive visual elements . . . , n−2, n−1, n+1, n+2, . . . , preceding or following the focus element n in the list, outside the focus area 20 at display positions arranged along two or more presentation lines l1, l2, . . . running through the focus area 20, the display positions relative to the focus area 20 being representative of a visual element's position in the list with respect to the focus element n.

In step S20, a user input may be received.

In step S21, the focus may be moved to a different visual element (n−1, n+1).

In step S22, in response to the user input, the different visual element n−1, n+1 may be displayed in the focus area 20 and the consecutive visual elements . . . , n−2, n−1, n, n+1, n+2, . . . , preceding or following the different visual element n−1, n+1 in the list, outside the focus area 20 at rearranged display positions on the presentation lines 11, 12, . . . , the rearranged display positions relative to the focus area 20 being representative of a visual element's position in the list with respect to the different visual element n−1, n+1.

Other embodiments of the disclosure may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein.

Accordingly, the present disclosure may be realized in hardware, software, or a combination of hardware and software. The present disclosure may be realized in a centralized fashion in at least one computer system, or in a distributed fashion where different units are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present disclosure may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present disclosure makes reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present disclosure not be limited to the particular embodiment disclosed, but that the present disclosure will include all embodiments falling within the scope of the appended claims.

What is claimed is:

1. A method, comprising:
controlling in an electronic device, a graphical user interface that is configured for browsing a list of visual elements, the controlling comprising:
displaying a plurality of consecutive visual elements of the list of visual elements, the displaying comprising:
displaying one of the consecutive visual elements, selected as a focus element, in a focus area of the graphical user interface, and
displaying one or more visual elements preceding and/or following the focus element in the list of visual elements, as non-focus elements outside the focus area, at display positions arranged along two or more presentation lines running through the focus area, wherein a display position of each visual element relative to the focus area being representative of a position of the visual element in the list of visual elements with respect to the focus element; and
in response to a user input that moves focus to a different visual element:
displaying the different visual element in the focus area, and
displaying one or more visual elements preceding and/or following the different visual element in the list of visual elements, as non-focus elements outside the focus area at rearranged display positions along the presentation lines, the rearranged display position of each visual element relative to the focus area being representative of a position of the visual element in the list of visual elements with respect to the different visual element.

2. The method of claim 1, comprising arranging the non-focus elements in a cyclical fashion on the presentation lines.

3. The method of claim 2, comprising configuring the cyclical fashion based on a cycle that is defined by the number of presentation lines and a corresponding number of consecutive visual elements in the list of visual elements, which are each arranged on a different one of the presentation lines using a defined order.

4. The method of claim 1, comprising displaying the non-focus elements with a distance to the focus element that reflects for a particular visual element its position in the list of visual elements with respect to the focus element, the distance increasing with every position farther away from the focus element in the list of visual elements.

5. The method of claim 1, comprising moving focus, in response to the user input, to the visual element directly preceding or directly following the focus element.

6. The method of claim 1, comprising moving focus, in response to the user input, to a selected one of the non-focus elements.

7. The method of claim 1, comprising displaying the focus element in a focus area positioned in a central location of the graphical user interface with a size larger than that of the non-focus elements.

8. The method of claim 1, comprising displaying the non-focus elements at display positions arranged along parallel presentation lines in a partially overlapping fashion.

9. The method of claim 1, comprising:
receiving a user input which deletes the focus element in the list of visual elements and moves focus to an adjacent visual element, directly preceding or directly following the focus element prior to its deletion; and
in response to the user input, displaying said adjacent visual element in the focus area and the remaining consecutive visual elements, preceding or following said adjacent visual element in the list of visual elements, as non-focus elements outside the focus area.

10. The method of claim 1, comprising returning, in response to a user input, to displaying the plurality of consecutive visual elements of the list of visual elements as arranged prior to the move to the different visual element.

11. A system, comprising:
one or more circuits for use in controlling a graphical user interface that is used for browsing a list of visual elements, the controlling comprising:
displaying a plurality of consecutive visual elements of the list of visual elements, wherein the displaying comprises:
displaying a visual element selected as a focus element, in a focus area of the graphical user interface, and
displaying one or more visual elements preceding and/or following the focus element in the list of visual elements, as non-focus elements outside the focus area, at display positions arranged along two or more presentation lines running through the focus area, wherein a display position of each visual element relative to the focus area being representative of a position of the visual element in the list of visual elements with respect to the focus element; and
in response to a user input that moves focus to a different visual element:
displaying the different visual element in the focus area, and
displaying one or more visual elements preceding and/or following the different visual element in the list of visual elements, as non-focus elements outside the focus area at rearranged display positions along the presentation lines, the rearranged display position of each visual element relative to the focus area being representative of a position of the visual element in the list of visual elements with respect to the different visual element.

12. The system of claim 11, wherein the one or more circuits are operable to control the graphical user interface to arrange the non-focus elements in a cyclical fashion on the presentation lines.

13. The system of claim 12, wherein the cyclical fashion is determined based on a cycle that is defined by the number of presentation lines and a corresponding number of consecutive visual elements in the list of visual elements, which are each arranged on a different one of the presentation lines using a defined order.

14. The system of claim 11, wherein the one or more circuits are operable to control the graphical user interface to display the non-focus elements with a distance to the focus element that reflects for a particular visual element its position in the list of visual elements with respect to the focus element, the distance increasing with every position farther away from the focus element in the list of visual elements.

15. The system of claim 11, wherein the one or more circuits are operable to control the graphical user interface to move focus, in response to the user input, to the visual element directly preceding or directly following the focus element.

16. The system of claim 11, wherein the one or more circuits are operable to control the graphical user interface to move focus, in response to the user input, to a selected one of the non-focus elements.

17. The system of claim 11, wherein the one or more circuits are operable to control the graphical user interface to display the focus element in a focus area positioned in a central location of the graphical user interface with a size larger than that of the non-focus elements.

18. The system of claim 11, wherein the one or more circuits are operable to control the graphical user interface to display the non-focus elements at display positions arranged along parallel presentation lines in a partially overlapping fashion.

19. The system of claim 11, wherein the one or more circuits are operable to:
receive a user input which deletes the focus element in the list of visual elements and moves focus to an adjacent visual element, directly preceding or directly following the focus element prior to its deletion; and
display, in response to the user input, said adjacent visual element in the focus area and the remaining consecutive visual elements, preceding or following said adjacent visual element in the list of visual elements, as non-focus elements outside the focus area.

20. The system of claim 11, wherein the one or more circuits are operable to control the graphical user interface to return, in response to a user input, to displaying the plurality of consecutive visual elements of the list of visual elements as arranged prior to the move to the different visual element.
